(19) United States
(12) Patent Application Publication
(10) Pub. No.: US 2024/0405395 A1
(43) Pub. Date: Dec. 5, 2024

(54) BATTERY MODULE

(71) Applicant: TOYOTA JIDOSHA KABUSHIKI KAISHA, Toyota-shi (JP)

(72) Inventors: Yutaroh GOTOH, Toyota-shi (JP); Tomoki IDOTA, Nagakute-shi (JP)

(73) Assignee: TOYOTA JIDOSHA KABUSHIKI KAISHA, Toyota-shi (JP)

(21) Appl. No.: 18/630,346

(22) Filed: Apr. 9, 2024

(30) Foreign Application Priority Data
Jun. 1, 2023 (JP) 2023-090740

(51) Int. Cl. H01M 50/588; H01M 10/613; H01M 50/204; H01M 50/342; H01M 50/367

(52) U.S. Cl. CPC H01M 50/588; H01M 10/613; H01M 50/3425; H01M 50/367; H01M 50/204

(57) ABSTRACT

The battery module includes a first battery group including a plurality of cells, a second battery group including a plurality of cells having safety valves, a cooler provided between the first battery group and the second battery group, and a protection member provided between the cooler and the second battery group and covering a portion of the second battery group that faces the cooler. The protection member is configured such that the thickness of the thin portion facing the safety valve is thinner than the thickness of the region other than the thin portion.

### CROSS-REFERENCE TO RELATED APPLICATION

This application claims priority to Japanese Patent Application No. 2023-090740 filed on Jun. 1, 2023 incorporated herein by reference in its entirety.

### BACKGROUND

### 1. Technical Field

The present disclosure relates to a battery module.

### 2. Description of Related Art

A battery module in which a plurality of cells are connected using a bus bar is known. For example, Japanese Unexamined Patent Application Publication No. 2022-083610 (JP 2022-083610 A) discloses a configuration in which a bus bar that electrically connects adjacent secondary batteries has a connection portion connected to an external terminal and a raised portion raised upward from the connection portion, and a voltage detection terminal is connected to the raised portion. With this configuration, it is possible to suppress moisture caused by dew condensation or the like adhering to or staying in the boundary portion between the bus bar and the voltage detection terminal.

### SUMMARY

When a cooler is provided in the battery module described above, water droplets caused by dew condensation or the like adhere to the cooler. Therefore, depending on the positional relationship between the battery module and the cooler, water droplets adhering from the cooler may move to the battery module, or water droplets may move to other battery modules when a plurality of battery modules are mounted. As a result, the battery module may be short-circuited due to water droplets adhering between bus bars or cells in the battery module.

The present disclosure has been made in order to address the above-described issue, and an object thereof is to provide a battery module that suppresses a short circuit caused by water droplets generated due to dew condensation or the like.

An aspect of the present disclosure provides a battery module including:
a first battery group including a plurality of cells;
a second battery group including a plurality of cells having safety valves;
a cooler provided between the first battery group and the second battery group; and
a protection member that covers a portion of the second battery group that faces the cooler. The protection member is configured such that a plate thickness of a predetermined first region that faces the safety valves is smaller than a plate thickness of a second region other than the first region.

With this configuration, it is possible to suppress water droplets having adhered to the cooler due to dew condensation or the like moving to the second battery module using the protection member. Further, since the protection member is configured such that the plate thickness of the first region that faces the safety valves is smaller than the plate thickness of the second region, it is possible to discharge a gas from the safety valves to the outside of the battery module in a predetermined direction, as an opening is easily formed in the first region even if the pressure of the gas increases when the gas is discharged from the safety valves to the outside of the cells.

In a certain embodiment, the first battery group may be disposed above the second battery group.

The cooler may be disposed below the first battery group.

With this configuration, it is possible to suppress water droplets having adhered to the cooler due to dew condensation or the like adhering to the second battery module using the protection member, even if such water droplets are dropped.

In a certain embodiment, further, the protection member may be provided with a guide member that constitutes a flow path of a gas from the safety valves to the first region.

The guide member may be configured such that a thickness of the guide member is larger than the thickness of the first region.

With this configuration, when a gas inside the cells is discharged from the safety valves to the outside of the cells, the pressure of the gas can be applied to the first region, and therefore it is possible to easily form an opening such as a crack in the first region. Therefore, the gas from the safety valves can be discharged to the outside of the battery module in a predetermined direction.

According to the present disclosure, it is possible to provide a battery module that suppresses a short circuit caused by water droplets generated due to dew condensation or the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining a configuration of a battery module according to the present embodiment;

FIG. 2 is a diagram illustrating an example of a configuration of a protection member;

FIG. 3 is a diagram illustrating an example of a positional relationship between a cooler, a protection member, and a second battery group;

FIG. 4 is a view for explaining a function of a protection member when gas is generated from a safety valve; and

FIG. 5 is a view for explaining a function of the protection member when the pressure of the gas discharged from the safety valve increases.

### DETAILED DESCRIPTION OF EMBODIMENTS

Hereinafter, embodiments of the present disclosure will be described in detail with reference to the drawings. In the drawings, the same or corresponding parts are denoted by the same reference numerals, and the description thereof will not be repeated.

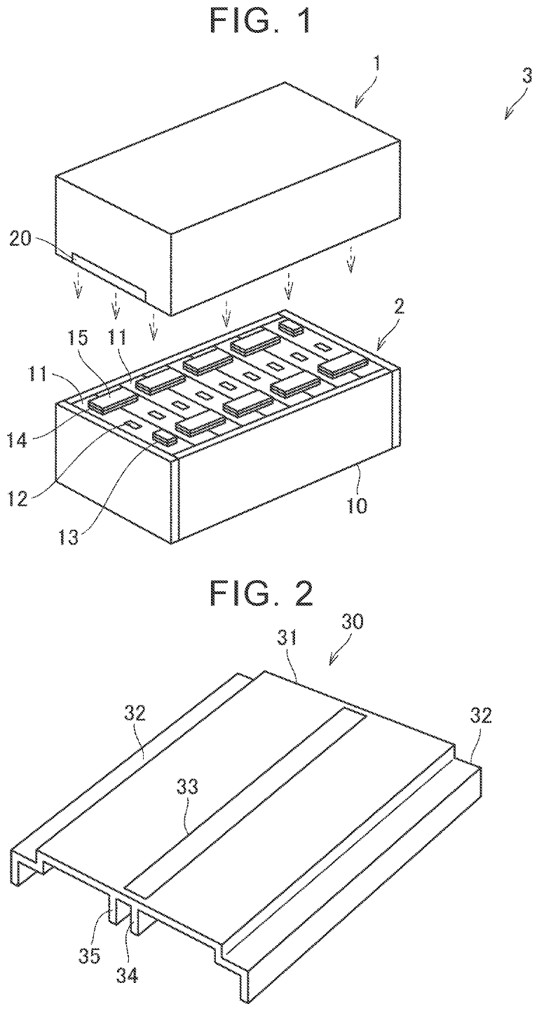

Hereinafter, the configuration of the battery module 3 according to the present embodiment will be described. FIG. 1 is a diagram for explaining a configuration of a battery module 3 according to the present embodiment. The battery module 3 is configured by combining a plurality of battery groups, for example. The battery module 3 may be used, for example, as a stationary power storage device. The battery module 3 may be used as an in-vehicle power storage device. In the present embodiment, a configuration in which the battery module 3 includes, for example, the first battery group 1, the second battery group 2, and the cooler 20 as illustrated in FIG. 1 will be described as an example.

Each of the first battery group 1 and the second battery group 2 includes a plurality of cells. In the present embodiment, the first battery group 1 and the second battery group 2 are configured by stacking the same number of cells. In the following description, an example of the configuration of the second battery group 2 will be typically described, but since the configuration of the first battery group 1 is also the same as the configuration of the second battery group 2, the detailed description thereof will not be repeated.

The second battery group 2 is configured by stacking a predetermined number of cells 11. The cell 11 is a cell of a rechargeable secondary battery, and the secondary battery includes, for example, a lithium-ion secondary battery, a nickel-hydrogen secondary battery, and the like. The cell 11 has, for example, a rectangular exterior. A safety valve 12, a positive electrode terminal 13, and a negative electrode terminal 14 are provided on an upper surface of the cell 11. In the plurality of cells 11, for example, the cells 11 are stacked such that the positive electrode terminals 13 of any of the cells 11 and the negative electrode terminals 14 of the cells 11 adjacent to the cells 11 are aligned in the stacking direction. The positive electrode terminal 13 of any of the cells 11 and the negative electrode terminal 14 of the cell 11 adjacent to the cell 11 are electrically connected by the bus bar 15. Therefore, except for the cell 11 at one end and the cell 11 at the other end in the stacking direction, the positive electrode terminal 13 of the cell 11 is electrically connected by using the negative electrode terminal 14 and the bus bar 15 of the cell 11 adjacent to the one side, and the negative electrode terminal 14 of the cell 11 is electrically connected by using the positive electrode terminal 13 and the bus bar 15 of the cell 11 adjacent to the other side. The positive electrode terminal 13 of the cell 11 at one end portion in the stacking direction is electrically connected to the negative electrode terminal 14 of the adjacent cell 11 using the bus bar 15, and the negative electrode terminal 14 is connected to the positive electrode terminal or the electric load of the other battery group. The negative electrode terminal 14 of the cell 11 at the other end portion in the stacking direction is electrically connected to the positive electrode terminal 13 of the adjacent cell 11 using the bus bar 15, and the positive electrode terminal 13 is connected to the negative electrode terminal or the electric load of the other battery group. The second battery group 2 includes a housing 10 that fixes the relative positional relationship of the plurality of cells 11, and is configured in a rectangular shape as a whole. In FIG. 1, the longitudinal direction of the second battery group 2 coincides with the stacking direction of the cells 11.

A cooler 20 is provided below the first battery group 1. The cooler 20 is, for example, a heat exchanger for performing heat exchange with the first battery group 1. The cooler 20 includes, for example, a heat sink and a cooling fin. The cooler 20 may further include, in addition to the heat sink and the cooling fins, a cooling medium, a medium passage through which the cooling medium flows, a pump that circulates the cooling medium, and the like. The cooling medium may be a gas or a liquid. FIG. 1 shows a relationship between positions where the first battery group 1 is provided directly above the second battery group 2. In FIG. 1, for convenience of explanation, a positional relationship in which the first battery group 1 and the second battery group 2 are separated from each other is shown, but the first battery group 1 and the second battery group 2 are arranged so as to have an appropriate distance relationship as the battery module 3.

In the battery module 3 having the above-described configuration, water droplets caused by dew condensation or the like may adhere to the cooler 20. When the cooler 20 uses a cooling medium, water droplets caused by dew condensation or the like are likely to adhere. Therefore, depending on the positional relationship between the second battery group 2 and the cooler 20, water droplets adhering from the cooler 20 may move to the second battery group 2. More specifically, in the case where the cooler 20 is provided directly above the second battery group 2 as in the present embodiment, when water droplets adhere to the cooler 20 due to dew condensation or the like, the adhered water droplets may drip to the second battery group 2. As a result, water droplets may enter between the plurality of bus bars 15 of the second battery group 2 and between the plurality of cells 11, and May be short-circuited by the entered water droplets.

Therefore, in the present embodiment, it is assumed that a protection member covering a portion of the second battery group 2 facing the cooler 20 is provided, and the protection member is configured such that the plate thickness of the predetermined first region facing the safety valve 12 of the cell 11 of the second battery group 2 is thinner than the plate thickness of the second region other than the first region.

In this way, it is possible to suppress the water droplets adhering to the cooler 20 by the protection member moving to the second battery group 2. Further, when the gas inside the cell 11 is discharged from the safety valve 12 to the outside of the cell 11, the opening portion is easily formed in the predetermined region by the pressure of the gas, so that the gas from the safety valve 12 can be discharged to the outside of the second battery group 2 in the predetermined direction.

FIG. 2 is a diagram illustrating an example of a configuration of the protection member 30. The protection member 30 is made of, for example, an insulating member such as resin. As shown in FIG. 2, the protection member 30 has a shape that covers the entire upper surface of the bus bar 15 of the second battery group 2 and the various terminals.

More specifically, the protection member 30 includes a flat portion 31, a bent portion 32, a thin portion 33, a first guide portion 34, and a second guide portion 35.

The flat portion 31 is formed of a planar member having a flat surface in the horizontal direction. The bent portion 32 is connected to both end portions of the flat portion 31 in the width direction (a direction orthogonal to the longitudinal direction of the second battery group 2), and is formed of a plate-shaped member bent in a stepped shape. The other end portion different from the one end portion connected to the flat portion 31 of the bent portion 32 is located outside the end portion in the width direction of the second battery group 2. That is, the entire upper surface of the second battery group 2 is covered by the flat portion 31 and the bent portion 32 of the protection member 30.

The thin portion 33 is set in a predetermined region (corresponding to the first region) in the center of the flat portion 31. For example, when the protection member 30 is provided on the upper surface of the second battery group 2, the predetermined region is set at a position facing each of the safety valves 12 of the plurality of cells 11 constituting the second battery group 2. The protection member 30 is configured such that the plate thickness of the thin portion 33 is thinner than the plate thickness of the flat portion 31 in a region (corresponding to the second region) other than the predetermined region.

Each of the first guide portion 34 and the second guide portion 35 is formed so as to protrude downward from a lower center portion of the flat portion 31. Each of the first guide portion 34 and the second guide portion 35 is a belt-like member formed continuously from one end to the other end in the longitudinal direction. The positional relationship between the connecting portion of the first guide portion 34 with the flat portion 31 and the connecting portion of the second guide portion 35 with the flat portion 31 is set so as to sandwich the thin portion 33. Therefore, each of the protruding belt-like members of the first guide portion 34 and the second guide portion 35 has a positional relationship facing each other. Therefore, when the protection member 30 is provided on the upper surface of the second battery group 2, a space surrounded by the thin portion 33, the first guide portion 34, the second guide portion 35, and the upper surface of the second battery group 2 including the plurality of safety valves 12 is formed.

Plate thickness in the thin portion 33, for example, gas is released from the safety valve 12, the pressure in the space described above is cracked in the thin portion 33 when exceeding the threshold value is set by experiments or the like so that a crack (opening) is formed.

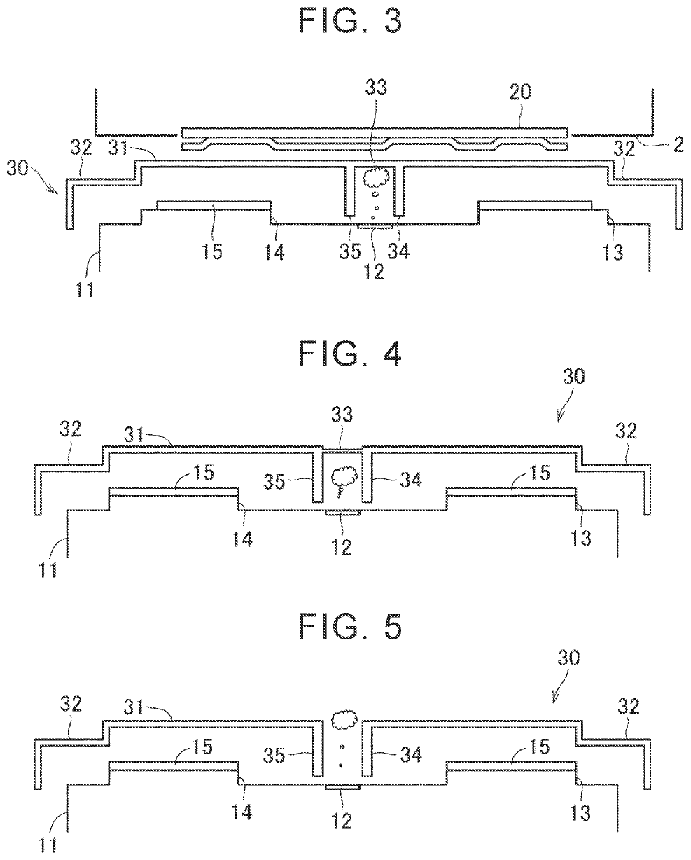

The operation of the battery module 3 according to the present embodiment as described above will be described with reference to FIGS. 3, 4, and 5.

FIG. 3 is a diagram illustrating an example of the positional relationship between the cooler 20, the protection member 30, and the second battery group 2. FIG. 3 is a cross-sectional view of a surface including a vertical direction and a width direction of the cooler 20 and the second battery group 2 in a state where the protection member 30 is provided. As shown in FIG. 3, the first battery group 1 is disposed directly above the second battery group 2, and the cooler 20 is provided on the bottom surface of the first battery group 1. As described above, the protection member 30 is provided so as to cover the entire upper surface of the second battery group 2. Therefore, the positional relationship in which the cooler 20 is positioned directly above the protection member 30 is established. With such a configuration, even when water droplets caused by dew condensation or the like adhere to the cooler 20 and drip to the lower second battery group 2, the dropped water droplets are suppressed from moving to the second battery group 2 by the protection member 30.

FIG. 4 is a diagram for describing the function of the protection member 30 when gas is generated from the safety valve 12. FIG. 4 is a cross-sectional view of a surface including a vertical direction and a width direction of the cooler 20 and the second battery group 2 in a state where the protection member 30 is provided. Gas is generated by deterioration or the like in any of the cells 11 of the plurality of cells 11, the pressure inside the cell 11 may be increased. When the pressure inside the cell 11 becomes equal to or higher than a certain value, as shown in FIG. 4, the gas is discharged from the safety valve 12. The gas discharged from the safety valve 12 stays in a space surrounded by the thin portion 33, the first guide portion 34, the second guide portion 35, and the upper surface of the second battery group 2 including the safety valve 12.

FIG. 5 is a diagram for explaining the function of the protection member 30 when the pressure of the gas discharged from the safety valve 12 increases. FIG. 5 is a cross-sectional view of a surface including a vertical direction and a width direction of the cooler 20 and the second battery group 2 in a state where the protection member 30 is provided. When the pressure in the above-described space exceeds the threshold value, since the plate thickness of the thin portion 33 is thinner than the plate thickness of the two members constituting the first guide portion 34 and the second guide portion 35, the member of the thin portion 33 is deformed, when the crack (opening) is formed, the gas flows out from the crack to the upper portion of the protection member 30. In this way, the gas discharged from the safety valve 12 can be guided directly above the safety valve 12.

As described above, according to the battery module 3 of the present embodiment, it is possible to suppress water droplets adhering to the cooler 20 by the protection member 30 adhering to the second battery group 2. Further, since the plate thickness of the thin portion 33 opposed to the safety valve 12 is configured to be thinner than the plate thickness of the region other than the thin portion 33, when the gas is discharged from the safety valve 12 to the outside of the cell 11, the opening is easily formed in the thin portion 33 by the pressure of the gas. Therefore, the gas from the safety valve 12 can be discharged directly above the protection member 30. Therefore, it is possible to provide a battery module that suppresses a short circuit caused by water droplets generated due to dew condensation or the like.

Further, since the first battery group 1 is disposed above the second battery group 2 and the cooler 20 is disposed below the first battery group 1, it is possible to suppress water droplets adhering to the cooler 20 dripping by the protection member 30 and moving to the second battery group 2.

Furthermore, the protection member 30 is provided with the first guide portion 34 and the second guide portion 35 that form the flow path of the gas from the safety valve 12 to the thin portion 33, and the plate thickness of the first guide portion 34 and the second guide portion 35 is configured to be larger than the plate thickness of the thin portion 33. Therefore, when the gas is discharged from the safety valve 12 to the outside of the cell 11, the pressure of the gas can be applied to the thin portion 33. Thus, it is possible to easily form an opening in the thin portion 33. As a result, the gas from the safety valve 12 can be discharged in a predetermined direction (directly above the protection member 30) of the second battery group 2.

Modification examples will be described below.

In the above-described embodiment, the configuration in which the first battery group 1 is provided directly above the second battery group 2 and the cooler 20 is provided on the bottom surface of the first battery group 1 has been described as an example, but the positional relationship between the first battery group 1, the second battery group 2, and the cooler 20 is not particularly limited to such a positional relationship.

It is sufficient that the water droplets adhering to the cooler 20 can be moved to the upper surface of the second battery group 2 without at least the protection member 30. Therefore, for example, the first battery group 1 and the second battery group 2 may be arranged in the horizontal direction, and the cooler 20 may be provided between the first battery group 1 and the second battery group 2. In such a configuration, even when water droplets adhere to the cooler 20 and the adhered water droplets scatter toward the second battery group 2 side due to traveling wind, cooling wind, or the like, the movement of the water droplets to the upper surface of the second battery group 2 is suppressed by the bent portion 32 at the end portion of the protection member 30.

Furthermore, in the above-described embodiment, it has been described that the continuous region along the stacking direction from the position immediately above the position of the safety valve 12 of one end cell 11 in the stacking direction of the plurality of cells 11 included in the second battery group 2 to the position immediately above the position of the safety valve 12 of the other end cell 11 is set as a thin portion 33, for example, a predetermined shape immediately above each of the safety valves 12 of the plurality of cells 11 included in the second battery group 2 (for example, circular or rectangular) region may be set as a thin portion 33 of the protection member 30.

Further, in the above-described embodiment, the thickness of the thin portion 33 is thinner than the plate thickness other than the thin portion 33 to facilitate the formation of the opening, for example, the plate thickness of the thin portion 33 is thinner than the plate thickness of the region other than the thin portion 33, and, the thin portion 33 may be formed of a different member of the same material as the region other than the thin portion 33, it may be configured to be a different member of different materials. In this way, the protection member 30 can be reused by replacing the member of the thin portion 33 with a new member after the tear or the like is formed.

Further, in the above-described embodiment, the battery module 3 has been described as an example of a configuration including the first battery group 1, the second battery group 2, and the cooler 20, but the battery module 3 may further include other battery groups other than the first battery group 1 and the second battery group 2, or may further include other coolers other than the cooler 20. In this case, the protection member 30 may be provided in a battery group (including the second battery group 2) in which water droplets adhering to the respective coolers can move. In this way, it is possible to suppress water droplets from adhering to the battery group in which the protection member 30 is provided.

Furthermore, in the above-described embodiment, the space formed by the first guide portion 34, the second guide portion 35, the thin portion 33, and the upper surface of the second battery group 2 of the protection member 30 has been described as being in communication with the stacking direction (longitudinal direction), but the space may be partitioned into a plurality of spaces by a partition plate. For example, a partition plate that partitions the space immediately above the safety valve 12 of any of the cells 11 and the space immediately above the safety valve 12 of the adjacent cells 11 may be provided between the first guide portion 34 and the second guide portion 35 of the protection member 30. With this configuration, since the opening is formed in the thin portion 33 immediately above when the gas is generated from the safety valve 12 of one of the cells 11 of the plurality of cells 11, the cell 11 in which the gas is generated can be quickly identified.

Note that all or a part of the above-described modification examples may be combined as appropriate.

It should be considered that the embodiment described herein is just an example in all respects and is not limitative. It is intended that the scope of the disclosure be defined by the appended claims rather than the foregoing description, and that all changes within the meaning and range of equivalency of the claims be embraced therein.

What is claimed is:

1. A battery module comprising:
a first battery group including a plurality of cells;
a second battery group including a plurality of cells having safety valves;
a cooler provided between the first battery group and the second battery group; and
a protection member that covers a portion of the second battery group that faces the cooler, wherein the protection member is configured such that a plate thickness of a predetermined first region that faces the safety valves is smaller than a plate thickness of a second region other than the first region.

2. The battery module according to claim 1, wherein:
the first battery group is disposed above the second battery group; and
the cooler is disposed below the first battery group.

3. The battery module according to claim 1, wherein:
the protection member is provided with a guide member that constitutes a flow path of a gas from the safety valves to the first region; and
the guide member is configured such that a thickness of the guide member is larger than the thickness of the first region.
